(19) United States
(12) Patent Application Publication
(10) Pub. No.: US 2009/0277249 A1
(43) Pub. Date: Nov. 12, 2009

(54) METHOD AND DEVICE FOR DETERMINING THE QUALITY OF SEAL OF A TEST OBJECT

(75) Inventors: Klaus Polster, Breitenbach (DE); Volker Dahm, Leipzig (DE); Ingo Stegemann, Suhl (DE)

Correspondence Address: MAYER & WILLIAMS PC, 251 NORTH AVENUE WEST, 2ND FLOOR, WESTFIELD, NJ, 07090, US

(73) Assignee: Volker Dahm, Leipzig (DE)

(21) Appl. No.: 12/297,202

(22) PCT Filed: Apr. 11, 2007
(86) PCT No.: PCT/EP2007/053502

§ 371 Date: Oct. 14, 2008

(30) Foreign Application Priority Data
Apr. 13, 2006 (DE) 10 2006 017 958.7

(51) Int. Cl. G01M 3/22

(52) U.S. Cl. 73/40.7

(57) ABSTRACT

The invention relates to a method for determining the quality of seal of a test object, a test object being initially arranged in a test chamber. The test object is filled with a tracer gas at a pressure exceeding that of the test chamber. The gas volume in the test chamber is then circulated through an external circuit, coupled to the test chamber, which includes a measuring chamber. The measurement of a quantitative parameter of the tracer gas is carried out with a sensor, arranged in the measuring chamber for carrying out said measurement and is within the circulated gas flow. The invention further relates to a device for determining the quality of seal of a test object, by means of which the above method can be carried out.

### BACKGROUND OF THE INVENTION

The present invention relates to a method and a device for determining the quality of seal of a test item/test object. Such a test object may be a container, a line or some other object having an interior cavity, such that a defined quality of seal of the interior cavity is to be tested.

The determination of the quality of seal of a test object is used for quality testing in many cases. For example, these may be containers for household chemicals or foods but also containers for working media in heating and air conditioning or in the automotive industry. Especially when environmentally critical media are to be carried or stored in the test object or when the functionality of a system depends on the exact quantity of the medium contained in it, a long-term quality seal is of great importance.

U.S. Pat. No. 5,553,483 A describes a system for detecting a leak in an object having an interior cavity. The test object is situated in a test chamber and filled with helium or some other tracer gas. An excess pressure prevails in the interior cavity of the object. The test chamber has an inlet opening through which the nitrogen or another carrier gas is introduced into the test chamber. In addition, the test chamber has an exhaust for the carrier gas, the exhaust being positioned in such a way that the carrier gas flowing into the test chamber largely flows around the test object before reaching the exhaust. If the object has a leak, then the emerging tracer gas flows into the test chamber. The tracer gas is conducted through the flow of the carrier gas into the exhaust, where there is a sensor for detecting the quantity of tracer gas. The accuracy of the system depends on the technical feasibility of a high vacuum in the test chamber. The greater the vacuum, the more accurately the leakage rate and can be determined and/or the smaller is the leakage rate to be detected. One disadvantage of this approach is the complexity of the system required due to the high vacuum to be achieved. The system must be robust and suitable for vacuum operation. The cycle time for testing multiple objects depends almost exclusively on the time required to produce the high vacuum because rapid suction removal of air causes the components of the system to freeze over and thus leads to falsification of measurement results. This method is therefore unsuitable because of the long measurement times for 100% testing of components in mass production with high cycle rates.

WO 2005/054806 A1 discloses a system and a method for determining the quality of seal of an object. The test object is situated in a test chamber and filled with hydrogen as the tracer gas. The pressure in the test chamber is reduced to 0.1 to 250 millibar. The test chamber has an inlet opening through which a carrier gas is introduced into the test chamber. In addition, the test chamber has an exhaust for the carrier gas which is positioned so that the carrier gas flowing into the test chamber largely flows around the test object before reaching the exhaust. The carrier gas is pumped out with a pump and passed by a sensor for determining the hydrogen content. If the object has a leak, hydrogen will flow into the test chamber where the hydrogen is directed together with the carrier gas to the sensor. One disadvantage of this approach is that in addition to hydrogen as a tracer gas, a carrier gas is needed, so that the system and the method are very complex. Again with this device, a quantity of gas must be withdrawn from the test chamber at a certain point in time and subsequently detected by the sensor. After the sampling point in time, the sensor cannot detect any changes which occur only after the withdrawal point in time of the sample. To obtain reliable results, it is necessary to wait for a uniform distribution of the test gas in the test chamber, which in turn results in long measurement cycles.

WO 02/075268 A1 discloses a method for determining a leak without using a carrier gas. The test object is filled with hydrogen or helium as the tracer gas. With the help of a sensor for the respective tracer gas, the concentration of the tracer gas in the vicinity of the test object is determined. Although the level of the concentration is an indication of the size of the leak, no accurate conclusions about the leakage rate can be drawn by using this method because the tracer gas concentration is not uniformly distributed.

WO 99/49290 discloses a method and a device for determining the quality of seal of containers. The container is arranged in a test chamber. The interior of the container is connected by two connections to lines through which an aerosol is directed to the container. The test chamber is filled with an aerosol-free gas on one side, while an aerosol sensor is connected by a line to the other side of the test chamber. Alternatively, the container may also be filled with the aerosol-gas and the test chamber may be filled with the aerosol, whereupon the aerosol sensor is to be connected by a line to the interior of the container. A switching valve may be used for switching between these two modes of operation.

GB Patent 2,314,421 A discloses a method for detecting leaks in heat exchangers. The interior cavity provided in the first circuit on the heat exchanger is filled with helium. The interior cavity provided for the second circuit on the heat exchanger is connected to a circulating system that includes a helium sensor.

JP 2005274291 A discloses a device for detecting leaks in a multichannel system. Such a multichannel system comprises an internal interior cavity which is situated inside an external interior cavity. The multichannel system is also introduced into a test chamber. A gas sensor is connected to the test chamber and to the interior cavity.

DE 42 28 149 A1 shows a vacuum meter for integral leakage testing with light gases. The test object introduced into a test container is filled with a test gas. Alternatively, the test container may be filled with the test gas.

DE 103 04 996 A1 discloses a leakage test method for pumps or pressurized containers. The test object filled with a test gas is situated beneath a test hood. The test hood has a sensor opening for connecting a sensor line. The test chamber atmosphere is rolled with fans so that the leakage gas escaping from the object is supplied to the sensor.

DE 10 2004 045 803 A1 discloses a leakage testing method and a device for doing so. This leakage testing device has a chamber that is partially or completely sealed off with respect to the environment, is filled with a filling gas and contains the test object filled with a test gas. The test gas emerging from a possible leak in the test object is detected with a partial pressure sensor which responds to the test gas but not to the filling gas. This allows measurements to be performed using simple means without a high vacuum and without a mass spectrometer. In a first variant of this previously known approach, the test object is in a hermetically sealed chamber, such that the partial pressure sensor is situated inside the chamber or on a wall of the chamber. It is proposed that a fan device be arranged opposite the partial pressure sensor in the text chamber so that the atoms of test gas are distributed uniformly in the chamber. As an alternative to this it is proposed that the gas in the chamber be conducted with the help of a fan through a bypass line to achieve the ventilation required in the chamber. In a second variant of this approach, the test object is in a chamber through which the filling gas flows continuously. Ambient air is drawn continuously through an incoming flow line with the help of a suction blower. The air flows first past the test object and then past the partial pressure sensor. The partial pressure sensor is arranged on a filling gas outlet or directly behind it.

### SUMMARY OF THE INVENTION

Starting from DE 10 2004 045 803 A1, the main object of the present invention consists of providing an improved method and a device for determining the quality of seal of a test object, i.e., an object having an interior cavity. In particular, the goal is to make the measurement more independent of the point in time of sampling and to shorten the waiting time until a reliable measured value is available without having to accept restrictions with regard to the measurability of extremely small leaks. In this way, 100% testing of components (test objects) should ultimately be made possible even when large numbers of parts are involved. No special carrier gas should preferably be necessary for the measurement. According to a first partial object of the invention, the device should be flexibly and rapidly adaptable to various measurement methods such as the inverse measurement. According to a second partial object of the invention, the determination of the quality of seal between multiple internal cavities within one test object should be made possible.

The main object is achieved by methods according to the accompanying claims 1 and 8 and by devices according to the dependent claims 9, 13, 14 and 15.

An important aspect of the present invention is to be seen in the fact that a sensor for determining the quantity of a tracer gas is located in a measuring chamber directly inside an external circuit in which the tracer gas emerging from a leak present in the test object is circulated jointly with the gas present in the test chamber. The measuring chamber provides a measurement position within the circulation circuit and in the simplest case may also be designed as a section of the pipes or lines of the circuit. The sensor therefore has the tracer gas that is to be measured flowing around it continuously, so that, first of all, an accurate measurement is possible after only a short period of time, and secondly, accurate measurements may also be performed repeatedly without having to repeat the sampling. Measurements are performed continuously in the circulating channel which communicates directly.

One particular advantage of the present invention consists of the fact that the inventive method and the inventive device can be implemented with conventional components. Neither a special carrier gas nor a high vacuum in the test chamber is needed. A short cycle time for testing multiple test objects is therefore made possible. Rough evacuation of the test chamber or filling it with a carrier gas is of course expedient, in order to be able to better detect the test gas.

Another advantage of the present invention is that the measurement is reproducible. As a result of the predetermined filling of the test object with tracer gas and a uniform circulation in the circuit, the tracer gas concentration at the sensor deviates only insignificantly in repeated measurements on the same test object or on a test object having the same leakage rate. Thus, the measurement certainty is greatly increased as a result of the present invention.

Another advantage of the present invention is derived from the fact that the area of the possible leak in the test object and the location of the measurement are spatially separate from one another. There is therefore no dependent relationship between the location of the leak on the test object and the concentration of the tracer gas on the sensor.

According to a modified embodiment, the device may also be designed as a dual-circuit device. Test objects having multiple separate internal cavities can therefore be tested for the quality of the seal.

Special embodiments of the present invention are defined in the dependent claims.

Additional advantages, details and further embodiments of the present invention are derived from the following description of several embodiments with reference to the drawings, in which:

### BRIEF DESCRIPTION OF THE FIGURES

FIG. 1 shows a basic diagram of a first embodiment of an inventive device;

FIG. 2 shows a basic diagram of a second embodiment of an inventive device for inverse measurements and accumulation measurements;

FIG. 3 shows a basic diagram of a third embodiment of an inventive device for testing objects having multiple internal cavities;

FIG. 4 shows a basic diagram of a fourth embodiment of an inventive device for testing multiple internal cavities of an object that are sealed off with respect to one another;

FIG. 5 shows two views of a circulation switching valve of the embodiment illustrated in FIG. 4; and

FIG. 6 shows a sectional view of the circulating switching valve shown in FIG. 5.

### DETAILED DESCRIPTION

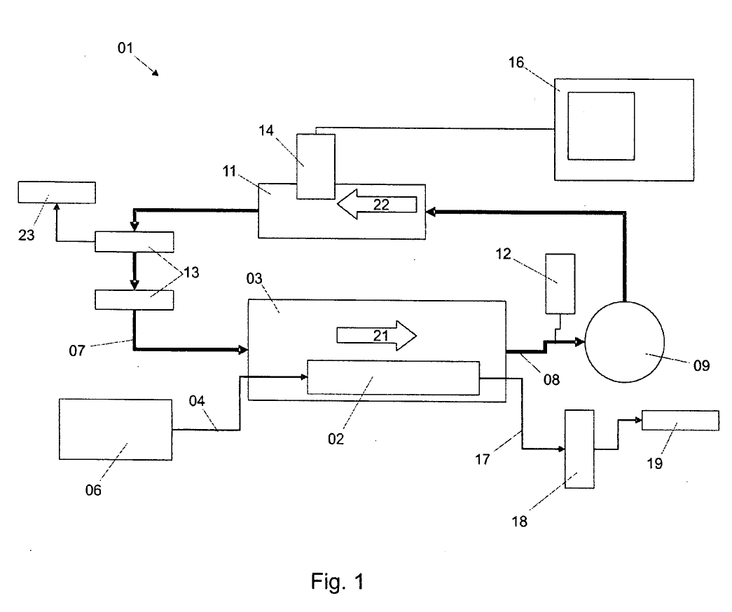

FIG. 1 shows a basic diagram of a preferred embodiment of an inventive device 01 for determining the quality of seal of a test object 02. The test object 02 is placed in a test chamber 03 of the device 01. The test chamber 03 may be designed in the form of a hood, which is placed on a base plate. Ambient air is in the test chamber 03. Alternatively, however, the test chamber may also be filled with a carrier gas or an inert gas. Likewise, evacuation of the test chamber before the start of the test operation is conceivable but not necessary.

The use openings in the interior cavity of the test object 02 are connected to a reservoir 06 to supply a forming gas through a filling line 04. The reservoir 06 for supplying the forming gas is expediently situated outside of the test chamber 03 and may consist of a container for storing the forming gas and a controllable pressure pump. The filling line 04 for supplying the forming gas is sealed with respect to the test chamber 03. If the test object 02 were not ideally tight, no forming gas would enter the test chamber 03.

The test chamber 03 has an inlet line 07 and an outlet line 08. The inlet line 07 and the outlet line 08 are preferably arranged in such a way that they are situated on two opposite sides of the test chamber 03, but at any rate, at a distance largely corresponding to the extent of the test chamber 03. In this way, dead volumes in the test chamber are prevented. Furthermore, the inlet line 07 and the outlet line 08 are designed so that any gas flow that might be present between the inlet line 07 and the outlet line 08 flows mostly around the test object 02.

The inlet line 07 and the outlet line 08 are connected to one another by an external circuit. This external circuit comprises a circulating unit 09 and a measuring chamber 11. In addition, the external circuit comprises a calibration leak 12 and switching valves 13. The gas in the test chamber 03 is circulated via the external circuit as soon as the test procedure starts. This circulation process is driven by the circulating unit 09, e.g., a pump with a volume throughput of 10 liters per second. The arrangement of the inlet line 07 and the outlet line 08 ensures that almost all the gas particles present in the test chamber 03 will be passed continuously through the external circuit.

A sensor 14 is provided in the measuring chamber 11. The sensor 14 serves to determine the quantity of forming gas. The gas circulating in the circulation to the sensor 14 may advantageously be supplied through a pitot tube to obtain a uniform dynamic pressure at the sensor. The sensor 14 and the pitot tube are designed so that there is a permanent exchange of gas at the sensor 14 due to the gas flowing into the measuring chamber 11. This ensures that the gas concentration at the sensor 14 will consistently correspond to the gas concentration in the external circuit. With the approaches known previously, only a small sample is taken from the gas volume, while a gas volume corresponding to 100 to 200 times or more the volume of a sample taken per circulation of the entire circuit flows past the sensor 14. The sensor 14 is connected to an analyzer unit 16. In addition, there are one or more filters (not shown) in the circulation for purification of the air.

The forming gas preferably consists of 95% nitrogen and 5% hydrogen. Hydrogen is suitable as a tracer gas in particular because highly sensitive semiconductor sensors have become available for more accurate determination of the quantity of hydrogen. Such semiconductor sensors can detect a hydrogen content of one particle per million particles. Furthermore, hydrogen is suitable because the background concentration of hydrogen in the ambient air amounts to only approx. 0.5 particle per one million particles. In a very small leak, the concentration of hydrogen in a forming gas flowing out amounts to approximately 5 particles per million particles. This provides a safe distance for determination of the quality of seal with forming gas under atmospheric conditions. Due to the presence of atmospheric conditions in the test chamber 03 and in the external circuit, the requirements of the quality of seal of the test chamber 03 and of the external circuit are low. This invention is also applicable for other tracer gases, inasmuch as a sensor suitable for the specific tracer gas used is available and the increased concentration of the tracer gas due to the leak that is to be measured differs significantly from the concentration of the tracer gas in the air. For example, helium or carbon dioxide may be considered for use as the tracer gas.

The use of forming gas to determine the quality of seal of the test object 02 is suitable in particular for leakage rates to be measured in the range of 10⁻⁵ to 10⁰ millibar-liters per second. This is a range in which neither the determination of the quality of seal with compressed air nor the use of helium as a tracer gas leads to a satisfactory cost benefit ratio. Forming gas in which the hydrogen component is increased allows the determination of leakage rates lower than 10⁻⁵ millibar per second. If pure hydrogen is used as the tracer gas, leakage rates of 10⁻⁸ millibar-liter per second can be detected. Leakage rates of this order of magnitude have in the past could be determined only by using helium as the tracer gas.

In an alternative embodiment, a technical vacuum is created in the test chamber 03 and in the external circuit. This is advantageous, for example, when a great pressure difference in comparison with the internal pressure of the test object 02 is necessary. The circulation of the remaining air, including any tracer gas that might be discharged through the external circuit, ensures that the tracer gas will flow around the sensor 14 in a concentration that corresponds to the concentration in the test chamber 03. This embodiment of the invention is also suitable for tracer gases, detection of which in air is problematical.

For the determination of the quality of seal of the test object 02, the use opening of the test object 02 is first connected to the filling line 04 to the means 06 for providing the forming gas with the test chamber 03 open. Many test objects have exactly one use opening. In the case of bottles and similar containers, this use opening is formed by the opening where the bottle is opened and closed for use. If the test object 02 has multiple use openings, then more filling lines 04 must be connected to test object 02 accordingly or some of the use openings must be closed. The filling lines 04 may be combined within the test chamber 03 to form one line or all of them may lead to the reservoir 06 to provide the forming gas. If the test object 02 does not have a use opening, the test object 02 is provided with an opening for determining the quality of seal, such that this opening is to be closed again after the end of the leakage test. The filling lines 04 and their connections to the test object 02 must have a much lower leakage rate than the leakage rate to be measured on the test object 02.

In addition, the test object 02 is connected to an emptying line 17. The emptying line 17 is connected to a cutoff valve 18. After conclusion of the leakage test, the cutoff valve 18 is opened so that forming gas is discharged out of the test object 02 into a collector 19 or can escape as exhaust air. When the test object 02 is completely connected to the filling lines 04 and the emptying line 17, the test chamber 03 is closed. If the test chamber 03 is designed as a hood, it must be placed on the base plate and sealed with respect to the base plate. For the start of the leakage test, the test object 02 must be filled with forming gas. The forming gas must have a certain excess pressure in the test object 02, this pressure to be selected as a function of the type of test object 02 and the leaks to be measured. The lower the leakage rates to be measured, the greater must be the pressure of the forming gas. In addition, the circulating unit 09 and the analyzer unit 16 are to be placed in operation. First, the air in test chamber 03 including the inlet line 07 and the outlet line 08 as well as in the measuring chamber 11 and in the circulating unit 09 is circulated. The composition of this air initially corresponds to that of the ambient air so that hydrogen is present at the sensor 14 in a typical concentration of approx. 0.5 particle per million particles. Especially in an embodiment of numerous successive tests, however, it is expedient to perform a starting measurement on the sensor 14 before filling the test object 02 with the tracer gas with the test chamber 03 closed in order to determine the concentration of tracer gas initially present.

If the test object 02 has one or more leaks, the forming gas will enter the test chamber 03 because an excess pressure prevails in the test object 02. Since the air in the test chamber 03 is circulated through the external circuit with a relatively great volume flow, the forming gas entering the test chamber 03 from the test object 02 is also circulated immediately through the external circuit. The mixture of air and forming gas is transported through the test chamber 03 in the direction 21 and through the measuring chamber 11 in the direction 22. Since the forming gas contains hydrogen, the hydrogen concentration at the sensor 14 increases without any mentionable delay. Consequently, it is possible to ascertain with the analyzer unit 16 whether the test object 02 has a leak. The level of the hydrogen concentration in the respective measurement period is a measure of the size of the leak or the sum of the leaks if there are several leaks. This method of leakage testing is also referred to as accumulation measurement.

After conclusion of the leakage test, the gas mixture in the external circuit is discharged into an exhaust air channel 23 by opening the switching valves 13.

The arrangement of the sensor in the circuit in which the gas contained in the test chamber 03 is circulated should cause a direct tie-in of the sensor into the complete gas volume without the requirement of sampling allowing a quasi-continuous measurement of the tracer gas concentration.

The inventive method and the inventive device may also be used for a permeation test. In a permeation test the permeability of the test object is determined. Because of the permeability of the material of the test object, the tracer gas also appears even without the presence of leaks (in the form of defects). Permeation tests are performed for rubber gloves, for example. In this case, the so-called breakthrough time is determined, among other things. The breakthrough time is the period of time between the start of the test and the point in time after which the permeability rate amounts to at least one microgram per square centimeter per minute. The permeability rate often increases drastically after the breakthrough time. With the inventive method and the inventive device, permeation tests can be performed with especially high precision because an accurate measurement of the chronological course of the escape of tracer gas is possible due to the circulation.

The inventive method and the inventive device may also be used for an inverse measurement. In an inverse measurement, the test chamber is filled with the tracer gas while an interior cavity of the test object has an inlet line and an outlet line for an external circuit. In the presence of a leak from the test chamber, the tracer gas enters the interior cavity of the test object and can then be detected in the external circuit as described above.

The inventive method and the inventive device can also be utilized for a partial measurement. Such a partial measurement is necessary when the test object 02 cannot be arranged entirely within the test chamber 03. If the test chamber 03 is formed by a hood, then the hood is sealed with respect to the test object 02. The hood encloses around the part of the surface of the test object 02 that can be tested with this partial test.

The inventive method and the inventive device may also be used for a bombing test for determining the quality of seal of a hermetically sealed test object. The bonding test is suitable for electronic components such as transistors or circuits, for example. The test object is first placed in a pressurized chamber, which is filled with a tracer gas, then the pressure in the pressurized chamber is increased to 5 bar, for example. The test object remains in the pressurized chamber for a defined period of time of 5 minutes, for example. During this period of time, tracer gas flows into the interior of the test object if the test object has leaks. Immediately thereafter, the test object is placed in the test chamber, where the circulation and the measurement are performed as described above. During this phase, the tracer gas that has penetrated into the test object comes out of it again. The true leakage rate can be deduced from the measured leakage rate.

The device 01 is calibrated in order to be able to accurately determine the leakage rate of the test object 02 with device 01 for determining the quality of seal. With an external calibration, the device is calibrated with laboratory standards or calibration leaks. Such calibration leaks are prepared by accredited laboratories in accordance with DIN [German Industrial Standards], for example. The calibration leaks may be integrated into an object that resembles the test object 02 and is free of leakage. Alternatively, one or more calibration leaks within the circulating circuit may be integrated into the device 01. The embodiment shown in FIG. 1 has a calibration leak 12 in an external circuit upstream from the calibration unit 09. Due to the inclusion of measured values with the calibration leak 12 on and off, the measurement capability of the device 01 is detected, so that there can be a finding of parameters for the filling of the test object 02 and the parameters for the circulation as well as a finding of the measurement sequences. In addition, these values can be compared with information provided by the manufacturer to be able to assess the measurement capability of the device 01 at the point in time of the external calibration.

An internal calibration is also performed with laboratory standards or calibration leaks. To do so, the analyzer unit 16 has an automatic equalization option. Standard data stored in the memory of analyzer unit 16 for the particular calibration leak 12 used are compared with measurement data recorded during the internal calibration for the calibration leak 12. In most cases, there are only minor deviations, so that only the parameters of the functional correlation between the leakage rate and the measured concentration of tracer gas which are used in the analyzer unit 16 need be adapted. If there are greater deviations, the analyzer unit 16 delivers an alarm that the device is to be recalibrated at the factory.

When the tracer gas strikes the surface of the sensor 14, the sensor 14 delivers an analog signal that changes in ratio to the amount of tracer gas striking it per unit of time. The change in this signal in a certain unit of time is a characteristic quantity for the amount of tracer gas flowing out of the leak. The analysis of this characteristic quantity may be performed for certain points in time, as an integral over a certain period of time or for the chronological course. The determination of such dimensions is possible because the sensor 14 has the tracer gas-air mixture that is circulated in the circulation flowing around it permanently. If the parameters for the filling of the test object 02 and the parameters for the circulation in the circuit are constant, the measures thereby ascertained are comparable with other measures, in particular with those of the calibrations. Consequently, accurate inferences regarding the leakage rate of the test object can be drawn with the functional correlation between the leakage rate and the dimensions for the measured tracer gas concentration as ascertained by calibration.

In comparison with other test methods in which a sample is taken from the test chamber and sent to a sensor, according to this invention is it possible to begin more rapidly with the measurement because a more or less uniform distribution is rapidly achieved due to the circulation process. Furthermore, a discontinuous measurement of the gas concentration can be performed by the sensor over a predefined measurement time. A function representing the leakage rate of the test object can be determined as soon as it is detected from the increase in concentration in the circulating stream thereby ascertained by using traditional mathematical methods.

The calibration of the device 01 and the guarantee of constant parameters for the filling of the test object 02 and for the circulation in the circuit allow an accurate determination of the leakage rate of the test object 02 over a large value range. The leakage rate may be ascertained in different units and output as plain text on the analyzer unit. For example, the units of cubic centimeters per minute or millibar-liters per second may be used for reporting the leakage rate. In addition, a decision as to whether the test object is good or bad may be output via the display. This decision may also be output optically or acoustically in some other way so that the operator can sort out the bad parts very rapidly and a short cycle time is ensured in testing multiple test objects.

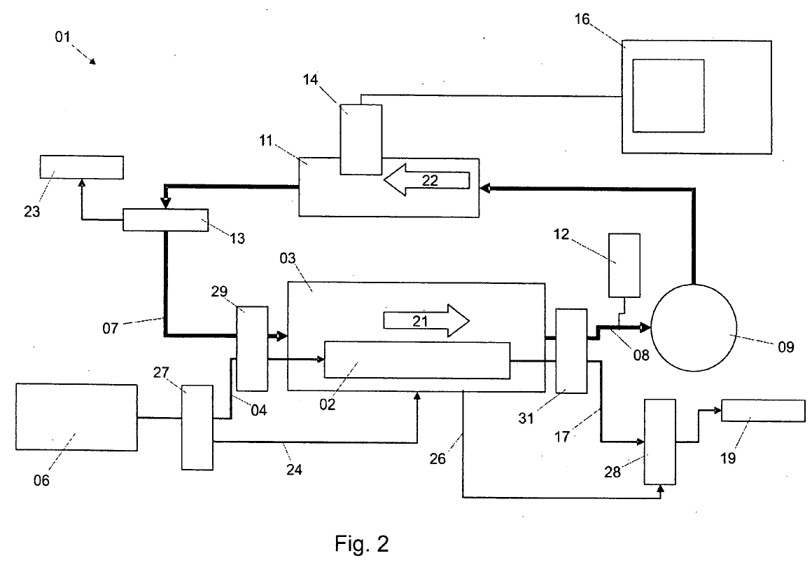

FIG. 2 shows a basic diagram of the inventive device 01 in a modified embodiment which allows an accumulation measurement as well as alternatively an inverse measurement. The device 01 additionally has a second filling line 24 for filling the test chamber 03 with forming gas and a second emptying line 26 for emptying the test chamber 03 in addition to the components described in general in conjunction with FIG. 1. The filling lines 04, 24 are connected to the reservoir 06 for providing forming gas via a second switching valve 27. Alternatively, the test chamber 03 or the test object 02 may be filled with forming gas by switching the second switching valve 27. The emptying lines 17, 26 lead to a third switching valve 28 in the same way. Thus either the test chamber 03 or the test object 02 can be emptied and forming gas can be directed to the collector 19. The switching valves 27, 28 are each to be switched in such a way that the forming gas stream is either sent from the reservoir 06 over the test chamber 03 to the collector 19 or from the reservoir 06 via the test object 02 to the collector 19.

A fourth switching valve 29 with which the volume circulated through the external circuit is supplied either to the test chamber 03 or to the test object 02 is provided in the inlet line 07. In the same way, in the outlet line 08 there is a fifth switching valve 31 with which the volume circulated through the external circuit is either removed from the test chamber 03 or from the test object 02. The switching valves 29, 31 are each to be switched in such a way that either the volume in the test chamber 03 or the volume in the test object 02 is circulated via the external circuit.

To perform an accumulation measurement, the third switching valve 27 in the filling lines 04, 24 and the fourth switching valve 28 in the emptying lines 17, 26 are to be switched in such a way that the forming gas is introduced into the test object 02 and is removed from the test object 02. The switching valves 29, 31 are each to be switched in such a way that the volume in the test chamber 03 is circulated through an external circuit. The functioning of the device 01 achieved in this way corresponds to the function of the embodiment shown in FIG. 1.

To perform an inverse measurement, the third switching value 27 in the filling lines 04, 24 and the fourth switching valve 28 in the emptying lines 17, 26 are to be switched in such a way that the forming gas is introduced into the test chamber 03 and is removed from the test chamber 03. The switching valves 29, 31 are each to be switched in such a way that the volume in the test object 02 is circulated through the external circuit. The functioning of the device 01 achieved in this way corresponds to the function of the embodiment mentioned above to perform inverse measurements.

The embodiment shown in FIG. 2 has the advantage that the device 01 can be configured very rapidly and easily for an accumulation measurement or an inverse measurement by switching the valves 27, 28, 29, 31.

The switching valves 27, 28, 29, 31 can also be formed by other switching devices for controlled inlet and outlet of the gases. The switching devices may also be formed by multi-way valves or slides, for example. The switching valves 29, 31 as well as the switching valves 27, 28 may be combined to form a switching device.

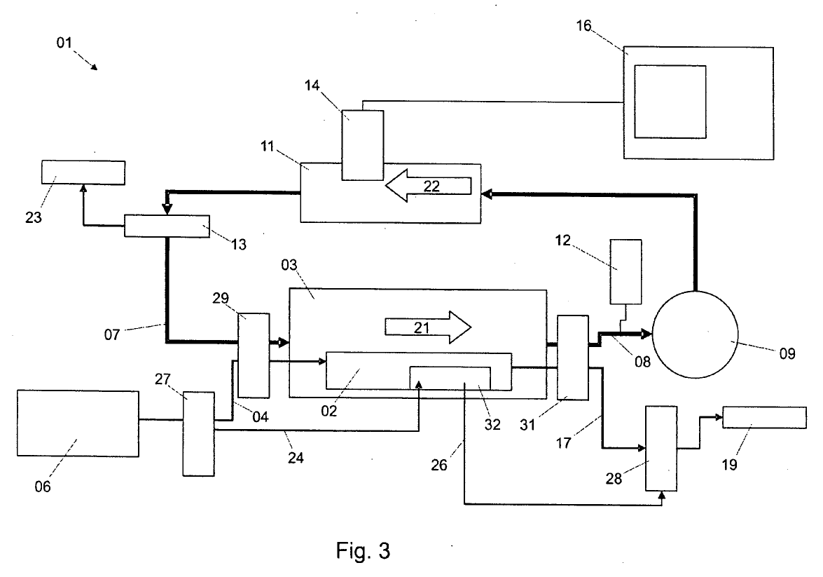

FIG. 3 shows a basic diagram of the inventive device 01 in a modified embodiment which allows a test of the quality of seal of test objects 02 which have at least one second interior cavity 32 in addition to the first interior cavity. With this embodiment, the quality of seal of the test object 02 with respect to the outside (i.e., with respect to the test chamber 03) as well as the quality of seal between the multiple internal cavities 02, 03 within the test object can be determined. The switching valves 27, 28, 29, 31 discussed in conjunction with FIG. 2 allow switching between measurements without requiring reconstruction of the device 01 or changes in the test object 02. The device 01 is altered with respect to the embodiment described in FIG. 2 only in that the second filling line 24 leads to the second interior cavity 32 in the test object 02 and the second emptying line 26 is connected to the second interior cavity 32.

To determine the quality of seal of the first interior cavity 02 with respect to the outside, the third switching valve 27 in the filling lines 04, 24 and the fourth switching valve 28 in the emptying lines 17, 26 are to be switched in such a way that the forming gas is introduced into the first interior cavity 02 and is removed from the first interior cavity 02. The switching valves 29, 31 are both to be switched in such a way that the volume in the test chamber 03 is circulated through the external circuit. The functioning of the device 01 achieved in this way corresponds to the function of the embodiment shown in FIG. 1.

To determine the quality of seal of the second interior cavity 32 with respect to the first interior cavity 02, the third switching valve 27 in the filling lines 04, 24 and the fourth switching valve 28 in the emptying lines 17, 26 are to be switched in such a way that the forming gas is introduced into the second interior cavity 32 and is removed from the second interior cavity 32. The switching valves 29, 31 are to be switched in such a way that the volume in the first interior cavity 02 is circulated through the external circuit. The first interior cavity 02 is thus in the function of the test chamber 03 in the embodiment shown in FIG. 1.

To determine the quality of seal of the second interior cavity 32 with respect to the outside, the third switching valve 27 in the filling lines 04, 24 and the fourth switching valve 28 in the emptying lines 17, 26 are to be switched in such a way that the forming gas is introduced into the second interior cavity 32 and is removed from the second interior cavity 32. The switching valves 29, 31 are both to be switched in such a way that the volume in the test chamber 03 is circulated through the external circuit.

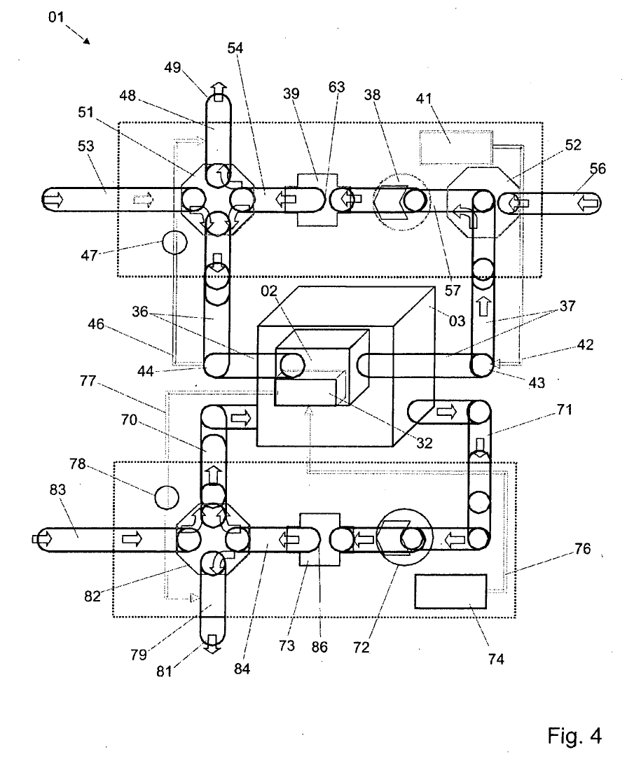

FIG. 4 shows a basic diagram of the inventive device 01 in a preferred embodiment for testing multiple internal cavities of a test object. This embodiment therefore has a first external circuit and a second external circuit. The first circuit comprises a first inlet line 36, a first outlet line 37, a first pump 38 and a first measuring chamber 39 arranged outside of the test chamber 03. The tracer gas is provided through a first reservoir 41, which is connected to the first circuit through a first filling line 42. The first filling line 42 opens into a switching valve 43 in the first outlet line 37. The switching valve 43 in the first outlet line 37 may be switched in such a way that circulation of the volume in the first circuit can take place or so that the tracer gas flows out of the first reservoir 41 through the first filling line 42 and through a part of the first outlet line 37 into the first interior cavity 02. Instead of the switching valve 43, alternatively a simple pipe connection between the first outlet line 37 and the first filling line 42 may be used if the escape of the tracer gas out of the first reservoir 41 can be controlled, e.g., by an outlet valve on the first reservoir 41.

To empty the first interior cavity 02, a switching valve 44 in the first inlet line 36 is switched. In a first position of the switching valve 44 in the first inlet line 36, the volume in the first circulation can be circulated. In a second position of the switching valve 44, the tracer gas flows out of the first interior cavity 02 through a part of the first inlet line 36 into a first emptying line 46. A first suction exhaust 47 with which the tracer gas can be drawn out of the first interior cavity 02 is provided in the first emptying line 46. The switching valve 44 in the first inlet line 36 may alternatively be formed by a simple pipe connection between the first inlet line 36 and the first emptying line 46, if the escape of the tracer gas can be prevented completely and controllably via the first suction exhaust 47. The first emptying line 46 opens into a first exhaust air channel 48 which in turn opens into a first collector 49.

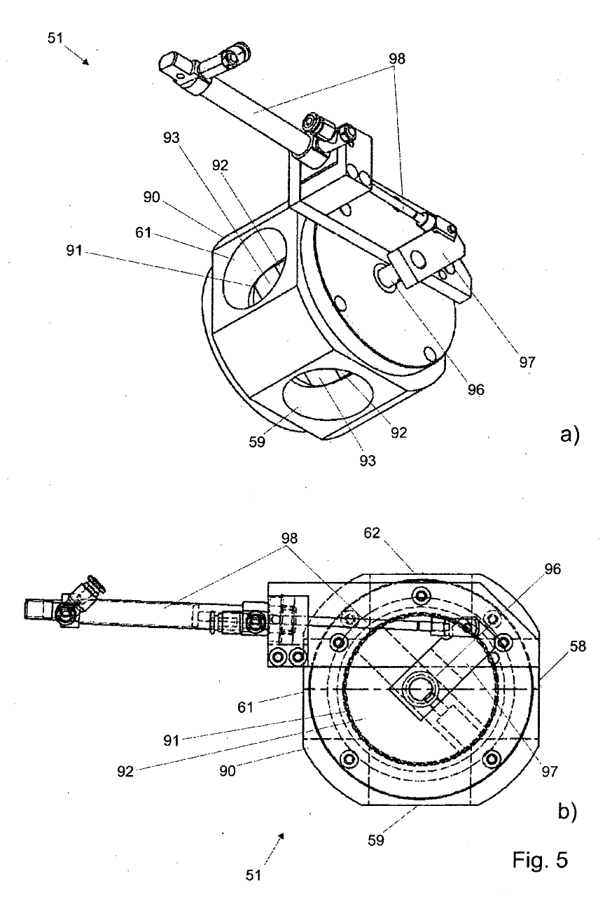

A first circulation switching valve 51 and a circulation inlet air valve 52 are also arranged in the first circuit. The first circulation switching valve 51 has four connections and two ways. In a first position of the circulation switching valve 51 the first circulation is closed. In a second position of the circulation switching valve 51 a first inlet air channel 53 is connected to the first inlet line 36 while at the same time a first measuring chamber outlet 54 is connected to the first exhaust air channel 48. In a first position of the circulation inlet air valve 52, the first circulation is closed. In a second position of the circulation inlet air valve 52 a measuring chamber inlet air channel 56 is connected to a first pump inlet line 57. The first circulation switching valve 51 is designed as a double valve with a first valve connection 58, a second valve connection 59, a third valve connection 61 and a fourth valve connection 62 (each shown in FIG. 5). With the first circulation switching valve 51, the first valve connection 58 is connected to the measuring chamber outlet 54, the second valve connection 59 is connected to the first inlet line 36, the third valve connection 61 is connected to the first inlet air channel 53 and the fourth valve connection 62 is connected to the first exhaust air channel 48. In the first position of the first circulation switching valve 51, the first valve connection 58 and the second valve connection 59 as well as the third valve connection 61 and the fourth valve connection 62 are connected, such that the connection between the third valve connection 61 and the fourth valve connection 62 is not utilized. In the second position of the first circulation switching valve 51, the first valve connection 58 and the fourth valve connection 62 as well as the second valve connection 59 and the third valve connection 61 are connected to one another. The circulation inlet air valve 52 is designed in the same way as the first circulation switching valve 51 but with only three valve connections.

A first pitot tube and a sensor 63 are provided in the first measuring chamber 39 as in the embodiments illustrated in FIGS. 1 to 3.

The second external circuit, in the same way as the first external circuit, comprises a second inlet line 70, a second outlet line 71, a second pump 72 and a second measuring chamber 73 which is arranged outside of the test chamber 03. The tracer gas is supplied through a second reservoir 74 which is connected by a second filling line 76 to the second interior cavity 32. The second interior cavity 32 is emptied through a second emptying line 77 in which there is a second suction exhaust 78. The second emptying line 77 opens into a second exhaust air channel 79, which in turn opens into a second collector 81.

In the second circulation, a second circulation switching valve 82 is also arranged. The second circulation switching valve 82 has four connections and two ways. The second circulation is closed in a first position of the second circulation switching valve 82. In a second position of the second circulation switching valve 82, a second inlet air channel 83 is connected to the second inlet line 70 while at the same time a second measuring chamber outlet 84 is connected to the second exhaust air channel 79. The second circulation switching valve 82 is identical in design to the first circulation switching valve 51.

In the second measuring chamber 73 there is a second pitot tube with a sensor 86, just as is the case with the first circulation.

With this preferred embodiment, the quality of seal of the test object 02 with respect to the outside (i.e., with respect to the test chamber 03) as well as the quality of seal between the two internal cavities 02, 32 within the test object can be determined. In contrast with the embodiment shown in FIG. 3, a measurement of the tracer gas emerging into the test chamber 03 as well as a measurement of the tracer gas emerging into the first interior cavity 02 can be performed without requiring switching or any changes in the connection.

At the start of a measurement, the test object 02 is introduced into the test chamber 03 and is connected to the first inlet line 36, the first outlet line 37, the second filling line 76 and the second emptying line 77. Then the second interior cavity 32 is filled with test gas from the second reservoir 74, whereupon a measurement may be performed in the first circuit with the first sensor 63. The tracer gas coming out of the second interior cavity 32 into the first interior cavity 02 is measured here. In the next step, the first interior cavity 02 is closed. Then a measurement is performed in the second circuit using the second sensor 86. In doing so, the tracer gas coming out of the second interior cavity 32 and into the test chamber 03 is measured. In the last step, the two internal cavities 02, 32 are both filled with the tracer gas. A measurement is performed in the second circuit using the second sensor 86 so that the tracer gas emerging from both internal cavities 02, 32 into the test chamber 03 is measured. If necessary, both internal cavities 02, 32 and the test chamber 03 can now be deaerated and the measurement can be repeated.

For emptying the two circuits including the first interior cavity 02 and the test chamber 03, the two circulating switching valves 51, 82 and the circulating inlet air valve 52 are each brought into the second switch position, whereupon ambient air is drawn in through the two inlet air channels 53, 83 and the measuring chamber inlet air channel 56 on the one hand and on the other hand the volume in the two circulations, including the first interior cavity 02 and the test chamber 03, is sent into the two collectors 49, 81 through the exhaust air channels 48, 79. Additionally or alternatively, the two internal cavities 02, 32 are emptied through the two emptying lines 46, 77 with the help of the two suction exhausts 47, 78. The aforementioned possibilities for emptying the two circuits, the two internal cavities 02, 32 and the test chamber 03 can also be performed individually during one measurement sequence.

The preferred embodiment shown in FIG. 4 is based on the idea of combining two inventive devices, each having one external circuit to form an inventive device having two external circuits. The two individual devices, each having one external circuit, are designed differently to allow circulation and measurement of the volume in the test chamber 03 on the one hand, while on the other hand allowing circulation and measurement of the volume in the first interior cavity 02.

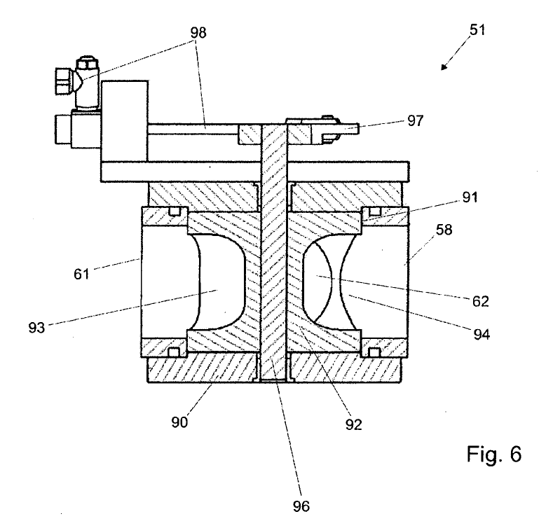

FIG. 5 shows two views of the first circulation switching valve 51 shown in FIG. 4. Diagram a) in FIG. 5 shows a perspective view and diagram b) in FIG. 5 shows a view from above. The circulation switching valve 51 comprises a valve body 90 on the circumference of which is arranged the first valve connection 58, the second valve connection 59, the third valve connection 61 and the fourth valve connection 62. The four valve connections 58, 59, 61, 62 are all in one plane and are arranged so they are uniformly distributed on a circle so that two neighboring valve connections 58, 59; 61, 62 each form an angle of 90 degrees to one another. The four valve connections 58, 59, 61, 62 constitute openings in the valve body 90, all of which open into a valve interior 91 of the valve body 90. The valve interior 91 has a cylindrical shape in which a valve rotor 92 is rotatably arranged. The valve rotor 92 has a first passage 93 and a second passage 94 (shown in FIG. 6). The two passages 93, 94 are each formed by a side recess in the cylindrical valve rotor 92 such that the recesses are opposite one another with respect to the axis of rotation of the valve rotor 92. The valve rotor 92, not including these recesses, has a cylindrical shape which is introduced into the cylindrical shape of the valve interior space 91 so that it fits accurately. There is a form-fitting connection between the valve rotor 92 and the valve interior space 91, not including the recesses forming the passages 93, 94 and not including the openings to the valve connections 58, 59, 61, 62. The two passages in 93, 94 are designed in such a way that they eliminate only a portion of the surface of the cylinder on this circumference at the height of the recess. No seal or sealing compound is needed between the valve interior space 91 and the valve rotor 92 to ensure a quality of seal between the two. The quality of seal is ensured only by the low manufacturing tolerances and the surface properties of the valve interior space 91 and the valve rotor 92.

The circulation switching valve 51 is shown in the second switch position in which the second valve connection 59 is connected to the third valve connection 61 via the first passage 93. In the same way, the first valve connection 58 is connected to the fourth valve connection 62 via the second passage 93. A change between the two switch positions takes place by rotation of the valve rotor 52 by one quarter revolution. If the circulation switching valve 51 is in the first switch position, then the first valve connection 58 is connected to the second valve connection 59 via the first passage 93 and the third valid connection 61 is connected to the fourth valve connection 62 via the second passage 93. To be able to make a change between the switch positions, a rotor shaft 96 of the valve rotor 92 is guided outward by means of which a torque can be transmitted to the valve rotor 92 from the outside. On the outer end of the rotor shaft 96 a knee lever 97 is attached, a pneumatically driven actuator 98 acting on the end thereof so as to form a knee lever drive. A drive of the longitudinally acting actuator 98 produces a rotation of the valve rotor 92 via the knee lever 97 so that the circulation switching device 51 can be switched from the first switch position into the second switch position and vice versa. Other drive variants for the valve rotor are of course also possible, e.g., utilizing the electromagnetic principle when the valve rotor is at the same time the rotor of a motor or is connected to such a motor in an active driving manner.

FIG. 6 shows a sectional view of the circulating switching valve 51 shown in FIG. 5. The first passage 93 and the second passage 94 in particular are shown. The first valve connection 58 is connected via the second valve passage 94 to the fourth valve connection 62. The two recesses forming the passages 93, 94 were reach created in the valve rotor 92 by a borehole created perpendicularly and at a distance from the axis of rotation of the valve rotor 92.

The circulation switching valve 51 shown here has the advantage that two valve paths can be switched easily and rapidly simply by rotation. The circulation switching valve 51 does not require any additional sealing means and is hardly susceptible to any trouble at all.

The circulation switching valve 51 shown here may also be adapted to other requirements. For example, the arrangement of the valve connections may be altered so that two valve connections are aligned in one direction. The arrangement may be varied as desired as long as the valve connections open into the valve interior space in such a way that they each have a connection to one of the two passages in the two switch positions. The passages may be formed by differently shaped recesses such as cup-shaped recesses. The valve rotor may also be formed by a flat plate, such that the space next to the two sides of the plate forms a passage on each side. The number of valve connections and the number of passages may also be adapted to requirements. For example, such a valve may be designed with three valve connections and two passages or with six valve connections and three passages. The rotation of the valve rotor may also be accomplished by a motor instead of being accomplished by the knee lever drive. The rotor shaft need not fundamentally be continued to the outside but instead may also be magnetically coupled. Such valves may of course also be used to advantage in other configurations, so that they are of general interest.

1. A method for determining the quality of a seal of a test object comprising the following steps:
arrangement of the test object in a test chamber;
filling the test object with a tracer gas with an excess pressure with respect to the test chamber;
circulating the gas volume in the test chamber through an external circuit which is connected to the test chamber and comprises a measuring chamber; and
measuring a quantitative characteristic variable of the tracer gas with a sensor which is arranged in the measuring chamber to perform the measurement and is in the circulated gas volume flow.

2. The method according to claim 1, additionally comprising a calibration step in which the quantitative characteristic variable of the tracer gas is measured when the test object is formed by a calibration leak.

3. The method according to claim 2, wherein for the measurement of the quantitative characteristic variable of the tracer gas, the sensor values obtained in testing the test object over a defined period of time are added up in a defined cycle.

4. The method according to claim 2, wherein for the measurement of the quantitative characteristic variable of the tracer gas, the time-dependent characteristics of the sensor values during the calibration and the testing of the test object are measured and compared.

5. The method according to claim 1, wherein the leakage rate of the test object is determined as a function of the quantitative characteristic variable of the tracer gas.

6. The method according to claim 1, wherein the test chamber is evacuated before the start of circulation and/or is filled with an inert gas.

7. The method according to claim 1 for determining the quality of seal of a hermetically sealed test object, whereby the test object is filled by arranging the test object in a pressurized chamber filled with the tracer gas for a predetermined period of time before introducing the test object into the test chamber.

8. The method for determining the quality of seal of a test object, comprising the following steps:
arranging the test object in a test chamber;
filling the test chamber with a tracer gas at excess pressure with respect to the interior of the test object;
circulating the gas volume in the interior of the test object through an external circuit connected to the test object comprising a measuring chamber; and
measuring a quantitative characteristic variable of the tracer gas with a sensor which is arranged in the measuring chamber for performing the measurement and which is in the circulated gas volume stream.

9. A device for determining the quality of seal of a test object, comprising:
a test chamber into which the test object can be introduced;
a reservoir with a tracer gas for filling the test object, such that a pressure exceeding the pressure in the test chamber is established in the test object;
a means for circulating the gas volume which is in the test chamber, comprising a circulating line, a pump and a measuring chamber, which is arranged outside of the test chamber; and
a sensor for quantitative detection of the tracer gas, such that the sensor is in the measuring chamber and is arranged inside the circulated gas volume.

10. The device according to claim 9, wherein the sensor is arranged at the end of a pitot tube which is arranged within the circulated gas volume.

11. The device according to claim 9 comprising an analyzer unit for detecting a time characteristic of the measured values of the sensor.

12. The device according to claim 11, wherein the analyzer unit determines a leakage rate of the test object from the measured values and outputs this leakage rate as an absolute value.

13. A device for determining the quality of seal of a test object, comprising:
a test chamber into which the test object can be introduced;
a reservoir for filling a volume with a tracer gas;
a first switching device such that in a first switch position, the test object is filled from the reservoir and a pressure that is higher than the pressure in the test chamber is established in the test object, such that the test chamber is filled from the reservoir in a second switch position and a pressure that is higher than the pressure in the test object is established in the test chamber;
a means for circulating a gas in a volume, comprising circuit lines, a pump and a measuring chamber which is arranged outside of the test chamber;
a second switching device such that in a first switch position the gas in the test chamber is circulated by the means for circulating a gas, and in a second switch position the gas in the test object is circulated by the means for circulating a gas; and
a sensor for quantitative detection of the tracer gas such that the sensor is in the measuring chamber and is arranged within the circulated gas volume.

14. A device for determining the quality of seal of a test object having a first interior cavity and a second interior cavity, comprising:
a test chamber into which the test object can be introduced;
a reservoir for filling a volume with a tracer gas;
a first switching device such that in a first switch position, the first interior cavity is filled from the reservoir and a pressure that is higher than the pressure in the test chamber is established in the first interior cavity, and in a second position the second interior cavity is filled from the reservoir and the pressure exceeding the pressure in the first interior cavity is established in the second interior cavity;
a means for circulating a gas in a volume, comprising circulating lines, a pump and a measuring chamber which is arranged outside of the test chamber;
a second switching device such that in a first switch position the gas in the test chamber is circulated by the means for circulating a gas, and in a second switch position the gas in the test object is circulated by the means for circulating a gas; and
a sensor for quantitative detection of the tracer gas such that the sensor is in the measuring chamber and is arranged within the circulated gas volume.

15. A device for determining the quality of seal of a test object having a first interior cavity and a second interior cavity, comprising:
a test chamber into which the test object can be introduced;
a first reservoir for filling the first interior cavity with a tracer gas;
a second reservoir for filling the second interior cavity with a tracer gas;
a first means for circulating a gas in a volume comprising first circulation lines, a first pump and a first measuring chamber arranged outside of the test chamber;
a second means for circulating a gas in the test chamber comprising second circulation lines, a second pump and a second measuring chamber which is arranged outside of the test chamber;
a first sensor for quantitative detection of the tracer gas such that the first sensor is in the first measuring chamber and is arranged inside the gas volume circulated by the first means; and
a second sensor for quantitative detection of the tracer gas such that the second sensor is in the second measuring chamber and is arranged inside the gas volume circulated by the second means.

16. The device according to claim 15, wherein the first reservoir for filling the first interior cavity is connected to the first interior cavity via one of the first circulation lines.

17. The device according to claim 15 wherein at least the first or the second means for circulating a gas also has a circulation switching device, which is connected to a first of the circulation lines and to a second of the circulation lines of the means for circulating a gas, such that in a first switch position of the circulation switching device the first of the circulation lines is connected to the second of the circulation lines and in a second switch position of the circulation switching device, the first of the circulation lines is connected to an exhaust air line on the one hand, while on the other hand, the second of the circulation lines is connected to an inlet air line.

18. The device according to claim 17, wherein the circulation switching device is formed by a double valve with a first valve connection, a second valve connection, a third valve connection and a fourth valve connection, such that in the first switch position, the first valve connection and the second valve connection as well as the third valve connection and the fourth valve connection are connected, while in the second switch position, the first valve connection and the fourth valve connection are connected and the second valve connection and the third valve connection are connected to one another.

19. The device according to claim 18,
wherein the double valve has a valve body:
on which at the circumference the first valve connection, second valve connection, the third valve connection and the fourth valve connection are each arranged in the form of an opening; and
which has a valve rotor;
wherein the valve rotor:
is rotatable between the first switch position and the second switch position in the valve body;
is introduced into the valve body in a form-fitting manner with respect to a valve interior space;
has a first passage in the form of an interior cavity which connects the first valve connection to the second valve connection in the first switch position and connects the second valve connection to the third valve connection in the second switch position; and
has a second passage in the form of an interior cavity which connects the third valve connection to the fourth valve connection in the first switch position and connects the first valve connection to the fourth valve connection in the second switch position.

20. The device according to claim 19, wherein the first valve connection, the second valve connection, the third valve connection and the fourth valve connection of the double valve are arranged in one plane and on a circle and are uniformly distributed on the circle such that an angle of 90° is formed between two neighboring valve connections; such that the valve rotor, not including the two passages, has a cylindrical shape which is introduced into a cylindrical shape of the valve interior space and has a rotor shaft for transmitting a torque to the valve rotor, which is guided to the outside through the valve body; and such that the first passage and the second passage are each formed by a lateral recess in the valve rotor.
